(19) United States
(12) Patent Application Publication
(10) Pub. No.: US 2005/0232226 A1
(43) Pub. Date: Oct. 20, 2005

(54) Large scale network

(76) Inventors: Hiroyuki Sasaki, Kawasaki (JP); Masayuki Sato, Kawasaki (JP)

Correspondence Address: KATTEN MUCHIN ROSENMAN LLP, 575 MADISON AVENUE, NEW YORK, NY, 10022-2585, US

(21) Appl. No.: 10/945,594

(22) Filed: Sep. 21, 2004

(30) Foreign Application Priority Data
Apr. 15, 2004 (JP) 2004-120653

(51) Int. Cl. H04L 1/00

(52) U.S. Cl. 370/351

(57) ABSTRACT

A large scale network comprising a network management system (11) being provided with a timer (8), wherein a network element directs a link up or link down to one port of the network element (12, 13) from the network management system and, after that, if a message indicating that the link up or link down is complete is received from a different port from a port from which the link up or link down has been directed within a predetermined time by the timer after an issuance of the link up or link down directions, the maintainer (7) of the network management system recognizes a physical connection between the port from which the link up or link down has been directed and a port from which the message has been sent to the network management system, whereby large scale network can be provided in which a maintainer of a network management system can easily confirm a link connection between network elements.

### FIELD OF THE INVENTION

The present invention relates to a network and, particularly, relates to a network in which a person who maintains a network management system constituting a large scale network can easily confirm a physical link connection between network elements subordinated to the network management system.

### BACKGROUND OF THE INVENTION

A large-scale and complicated network such as a carrier network is comprised of a network management system and a plurality of network elements subordinated thereto. In such a large scale network, an engineering work for a physical link connection between network elements requires that a detail work figure and a manual are prepared previously and a great care is paid thereto to complete the work without mistakes. However, the network elements can be placed at different locations, and cannot be connected one-on-one in the most cases. Consequently, a significant amount of time is actually required to complete the work for a physical link connection without mistakes.

As a prior art for confirming a physical link connection, a method for confirming conduction between the network elements by transmitting a packet such as PING (Packet InterNet Groper) from a router or the like connected to the outside is generally used. However, this method requires not only a device for sending/receiving the packet but also work to connect the device to the network elements. Moreover, various settings for the network elements must be completed before the packet can be transmitted.

On the other hand, another prior art for confirming a physical link connection without a particular outside device, for example, is disclosed in Patent Reference 1. In the technology disclosed in the Patent Reference 1, a signal is transmitted to a link subject to mutual testing between network elements, and the link connection can be confirmed by the result. However, in an art disclosed in the Patent Reference 1, the network elements at both terminals of the link have to equipped with a system disclosed in the Patent Reference 1, and the use can be restricted in view of versatility.

Moreover, a prior art regarding an interruption detection between a media converter and the network elements is disclosed in Patent Reference 2. The prior art is, like that in Patent Reference 1, a method where a particular message is sent/received between both link ends, and therefore, the use is restricted in view of versatility.
[Patent Reference 1] Japanese Unexamined Patent Publication (Kokai) No. 8-331126
[Patent Reference 2] Japanese Unexamined Patent Publication (Kokai) No. 2002-261768

### DISCLOSURE OF THE INVENTION

[Problems to be Solved by the Invention]

In consideration of the problems in the prior art above, the present invention is aimed to provide a network in which a maintainer of a network management system for managing network elements can easily check a link connection between the network elements without going to a site where the network elements are placed and without a necessity of sending/receiving a particular message between both link ends.

[Means for Solving Problems]

In order to achieve the above purpose, according to a first aspect of the invention, there is provided a network, comprising network elements and a network management system to manage the network elements, wherein the network elements performs a link up to change the status of one port among the plural ports from an unusable state to a usable state or a link down to change the status of one port among the plural ports from a usable state to an unusable state according to directions from the network management system,
and wherein after the instruction of the link up operation or link down operation are supplied to the network elements, the network management system monitors messages of responding link up or responding link down from the plural network elements to be managed, and when the responding link up or responding link down is received from a port which is different from a port from which the link up or link down has been directed within a predetermined time before or after issuance of the link up or link down directions, a physical connection status between the port from which the link up or link down has been directed and the port from which the responding link up or responding link down has been sent to the network management system is recognized.

According to a second aspect of the invention, in a structure of the above first aspect, the network management system comprises a database to hold a network structure regarding a physical connection between the network elements, a comparison means to determine whether a status of the physical connection between ports recognized by the responding link up or link down is identical to set information stored in the database, and an indication means to indicate the comparison result on the network management system.

According to a third aspect of the invention, in a structure of the above second aspect, each of the network elements is provided with an interface port between the opposed network elements, a connector detection switch provided on the interface port, to detect a receipt of a connector, and a switch output notification means to notify the output of the connector detection switch to the network management system and, if the responding link up or link down message is not received from a port different from a port from which the link up or link down has been directed within said predetermined time, when a link up or link down direction is issued to one port of a physical link registered in the network structuring information stored in the network management system, the reason that no message is received can be recognized, according to the content notified by the switch output notification means.

According to a fourth aspect of the invention, in a structure of the above first aspect, a function to monitor link up messages which are autonomously generated upon connection of a cable to a port of the network element in order to establish a cable connection of a physical link between the network elements in the network management system is provided and when the network management system receives the link up message, if another link up message is received from a different port in the to-be-monitored network element group within a predetermined time before or after the receipt of the message, the network management system determines that the two ports are physically connected.

According to a fifth aspect of the invention, in a structure of any one of the above first to third aspects, if the network management system receives a response linkup/down message from two or more ports other than those from which the link up or link down has been directed within a predetermined time, the directions of the link up or link down are repeated until the number of the messages of the response link up or link down decreases to one within a predetermined time before or after the receipt of the directions of the link up or link down from the network management system to thereby confirm a link connection between the network elements.

[Effect of the Invention]

According to the first aspect of the invention, a physical connection between arbitrary ports of the network elements subordinated to the network management system can be detected without sending a maintainer of the network management system to the site of the network elements and without using a particular device.

According to the second aspect of the invention, information as to whether an expected physical connection is identical to the actual physical connection can be notified to a maintainer of the network management system.

According to the third aspect of the invention, an installation implementation status of the physical link can be detected. Namely, if no physical connection is detected by the structure according to the third aspect of the invention, it can be determined whether no connection is caused by failure to implement the installation of the physical link or caused by some interruption on the link which has been installed.

According to the fourth aspect of the invention, a difference from the first aspect resides in a detection of the physical link in association with the maintaining operation on the network element side. Consequently, the status of the physical link can be immediately obtained in the management system in association with the installation implementation of the physical link by the maintainer of the network elements.

In the first to third aspects, it is assumed that a message regarding the link up/link down is sent from two ports or one port subordinated to the network management system to the network management system within a predetermined time. However, if, for example, a link installation implementation is carried out in the same time, the message may be received from three or more ports. However, according to the fifth aspect, the opposite ports at the link ends can be specified.

### BRIEF EXPLANATION OF THE DRAWINGS

FIG. 1 is a block diagram showing a network structure of a large scale network according to a first embodiment of the present invention;

FIG. 2 and FIG. 3 are sequence diagrams illustrating a physical connection detection operation of a transmission link in the large scale network shown in FIG. 1;

FIG. 4 is a block diagram showing a network structure of a large scale network according to a second embodiment of the present invention;

FIG. 5 and FIG. 6 are sequence diagrams illustrating a physical connection detection operation of a transmission link in the large scale network shown in FIG. 4;

FIG. 7 is a block diagram showing a network structure of a large scale network according to a third embodiment of the present invention;

FIG. 8 is a unit of a sequence diagram illustrating a physical connection detection operation of a transmission link in the large scale network shown in FIG. 7;

FIG. 9 and FIG. 10 are sequence diagrams following FIG. 8;

FIG. 11 is a schematic view of a connector containment detection switch;

FIG. 12 and FIG. 13 are sequence diagrams illustrating a physical connection detection operation of a transmission link according to a fourth embodiment of the present invention in the large scale network shown in FIG. 7;

FIG. 14 and FIG. 15 are sequence diagrams illustrating a physical connection detection operation of a transmission link according to a fifth embodiment of the present invention in the large scale network shown in FIG. 7;

FIG. 16 and FIG. 17 are sequence diagrams illustrating a physical connection detection operation of a transmission link according to a sixth embodiment of the present invention in the large scale network shown in FIG. 7;

FIG. 18 is a sequence diagram following FIG. 17;

FIG. 19 is a sequence diagram illustrating a physical connection detection operation of a transmission link according to a seventh embodiment of the present invention in the large scale network shown in FIG. 7;

FIG. 20 is sequence diagram following FIG. 19;

FIG. 21 is a sequence diagram following FIG. 20;

FIG. 22 is a sequence diagram illustrating a physical connection detection operation of a transmission link according to eighth embodiment of the present invention in the large scale network shown in FIG. 7;

FIG. 23 is a sequence diagram following FIG. 22; and

FIG. 24 is a sequence diagram following FIG. 23.

### EMBODIMENT 1

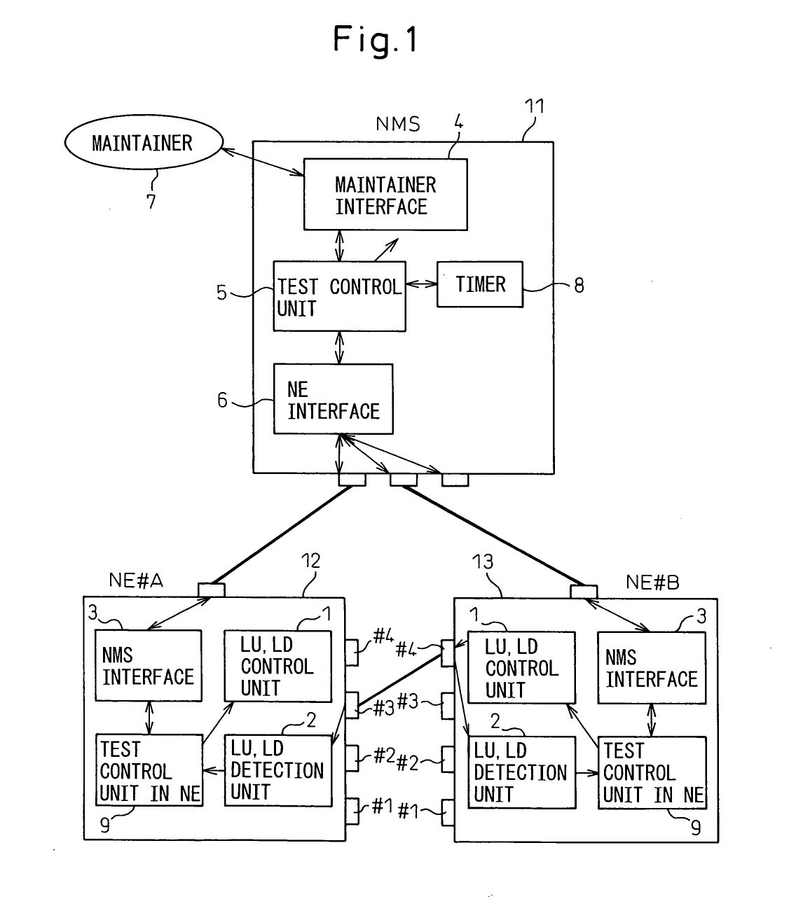

FIG. 1 is a block diagram showing a large scale network according to a first embodiment of the present invention. In the drawing, numeral 11 represents a network management system and numerals 12 and 13 represent network elements subordinated to the network management system 11. The large scale network is, for example, an enterprise network or a public telephone network. In the drawing, only two network elements are shown for the sake of simplification but, in practice, three or more network elements can be subordinated to the network management system 11.

The network element 12 (NE#A) is equipped with one or more cards, each having a plurality of ports #1 to #4 to connect to the other network elements. Each of the cards is comprised of a link up/link down (LU, LD) control unit 1 to control an occurrence of link-up which changes the status of each of the ports #1 to #4 from an inaccessible position to an accessible position and link-down which changes the status of each of the ports #1 to #4 from an accessible position to an inaccessible position, a link up/link down (LU, LD) detection unit 2 to detect the link up or link down, an NMS interface 3 to communicate with the network management system, and a test control unit 9 in NE used to carry out a test in the network element 12.

The structure of the network element 13 (NE#B) is the same as that of the network element 12, and the corresponding components are assigned the same numerals.

The network management system 11 (NMS) is comprised of a maintainer interface 4 to communicate with a maintainer 7, a test control unit 5, an NE interface 6 to communicate with the network element 12 or 13, and is further comprised of a timer 8 to count a lapse of a predetermined time from the issuance of the instructions of the link up/link down by the network management system to the network element. The maintainer interface 11 is provided with a keyboard and a display (not shown), etc.

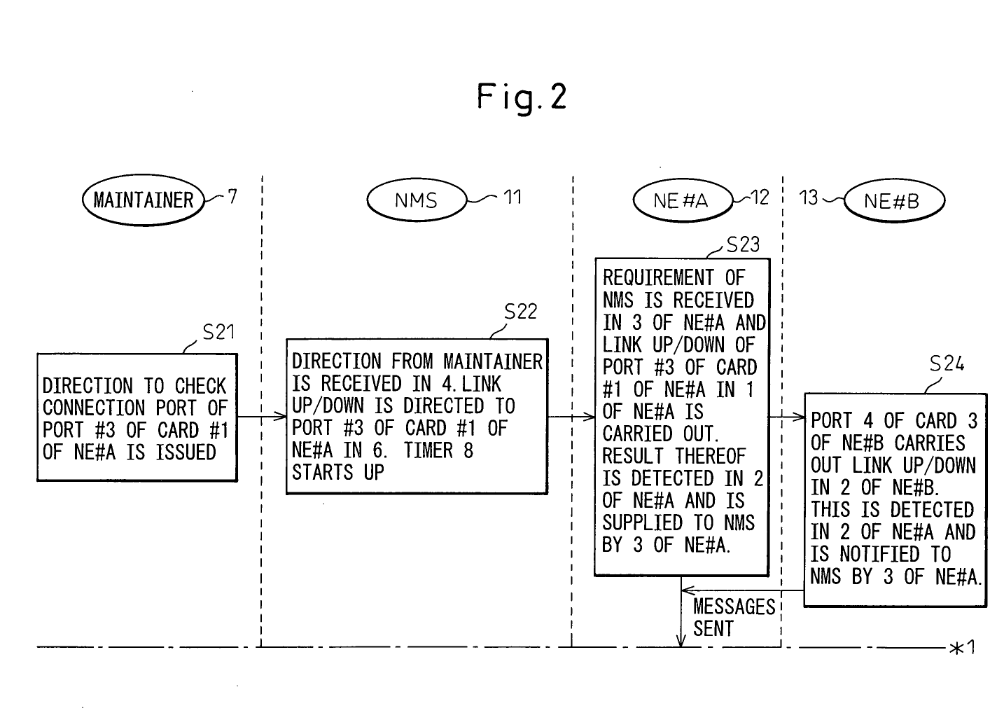

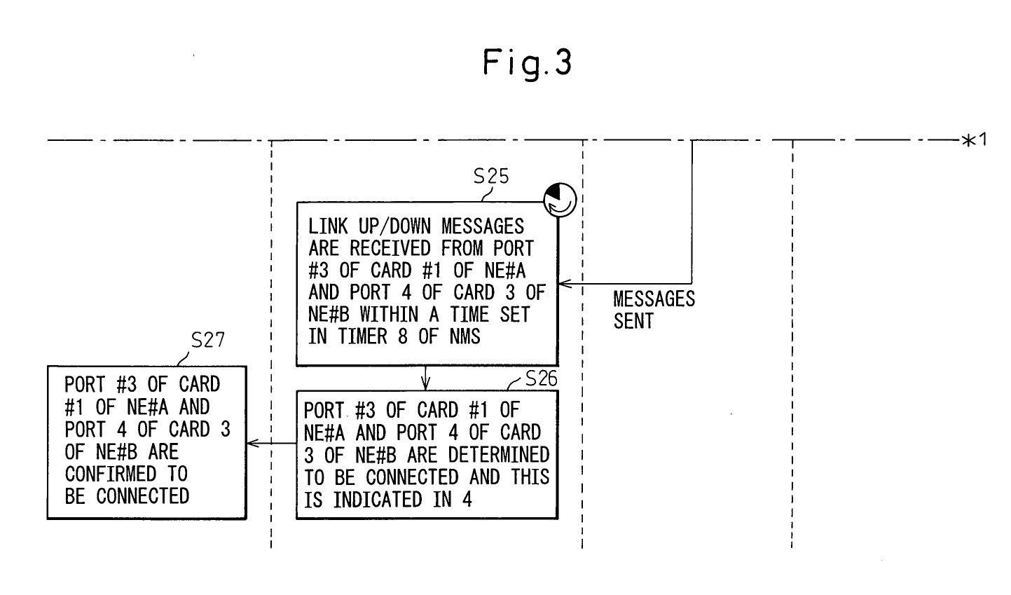

FIG. 2 and FIG. 3 show sequence diagrams illustrating a physical connection detection operation of a transmission link in a large scale network shown in FIG. 1. A physical connection detection operation of a transmission link will be explained with reference to FIGS. 1, 2 and 3.

First, in step S21, the maintainer 7 of the network management system 11 gives an instruction to the network management system 11 in order to confirm, for example, the status of a connection port of the port #3 of the card #1 of the network element 12 (NE#A).

In step S22, the network management system 11 receives the instructions from the maintainer 7 in the maintainer interface 4. After that, link up/down instructions are issued to the port #3 of the card #1 of the network element 12 (NE#A) via the test control unit 5 and the NE interface 6. If the port is in a link up state, the instructions are issued in the order of link up and link down, and if the port is in a link down state, the instructions are issued in the order of link down and link up. After the instructions are issued to the port, the timer 8 starts in the network management system 11.

The network element 12, which has received the instructions for link up/down, receives a request from the network management system 11 in the NMS Interface 3 in step S23, and links up/down to the port #3 of the card #1 via the test control unit 9 and the link up/down (LU, LD) control unit 1.

After that, in step S23, the link up/down (LU, LD) control unit 1 automatically sends a link up/down instructions to a port of another network element, for example, the port #4 of the card #3 of the network element 13 (NE#B). In response to this instruction, the port #4 of the card #3 of the network element 12 (NE#A) is in a link up/down state in step S24. This is detected in the link up/down (LU, LD) detection unit 2 and is notified to the network management system (NMS) 11 in the NMS interface 3.

In step S25, the network management system (NMS) 11 waits for a message indicating that the link up/down has been completed from a network element among a group of network elements, other than the network element 12, which are subordinated to the network management system 11 during operation of the timer 8. If the message indicating that the link up/down has been completed is received from a network element, for example, the network element 13 (NE#B), among a group of network elements, other than the network element 12, within a predetermined time during operation of the timer 8, it is determined that the port #3 of the card #1 of the network element 12 (NE#A) is physically connected to the port #4 of the card #3 of the network element 13 (NE#B), and the physical connection is indicated on a display of the maintainer interface 4 of the network management system 11 in step S26.

The maintainer 7 can confirm, through the indication on the display, that the port #3 of the card #1 of the network element 12 (NE#A) is connected to the port #4 of the card #3 of the network element 13 (NE#B) in step S27.

### EMBODIMENT 2

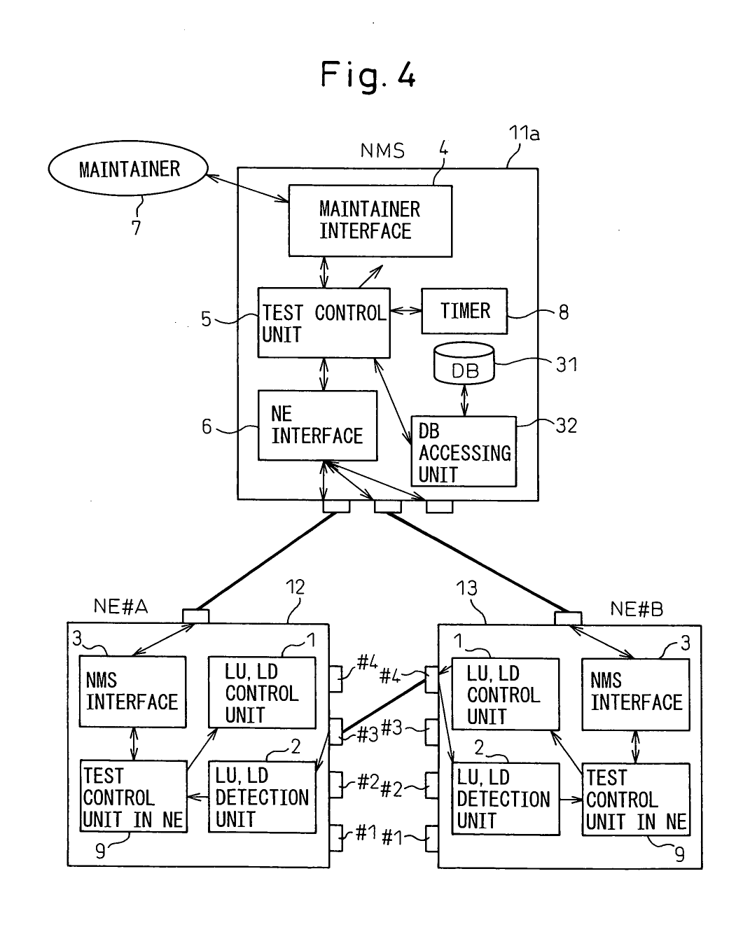

FIG. 4 shows a block diagram showing a large scale network structure according to a second embodiment of the present invention. The drawing is different from FIG. 1 in that the network management system 11a is further comprising of a database (DB) 31 and a database accessing unit 32. The remaining structure is identical to that shown in FIG. 1, and no duplicate explanation will be given.

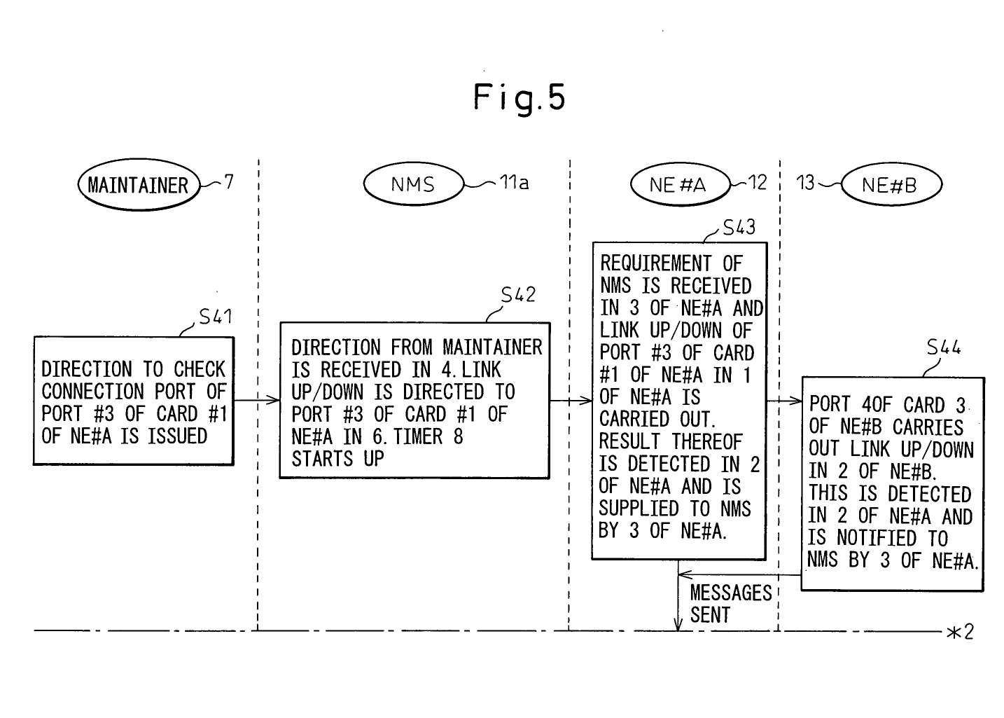

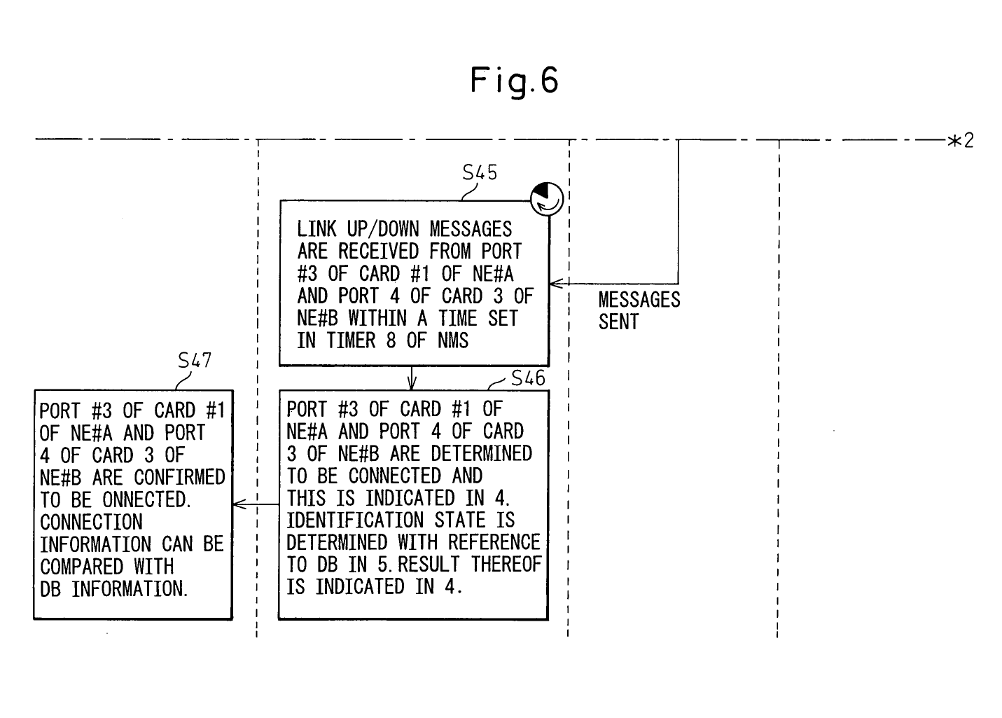

FIG. 5 and FIG. 6 show sequence diagrams illustrating a physical connection detecting operation of a transmission link in a large scale network shown in FIG. 4. The physical connection detecting operation of the transmission link will be described with reference to FIGS. 4-6.

The database (DB) 31 has previously stored information therein about a port to connect.

First, in step S41, the maintainer 7 of the network management system 11 issues directions to the network management system 11 to check the status of, for example, a connection port of the port #3 of the card #1 of the network element 12 (NE#A) and, for example, a connection port of the port#4 of the card #3, of the network element 13 (NE#B).

The following operation from the steps S42 to S45 it identical to the operation from the steps S22 to S25 illustrated in FIGS. 2 and 3, and no duplicate explanation will be given. A difference from that illustrated in FIGS. 2 and 3 is that in the network management system 11a, if the message is received from the network element 13 (NE#B) within a predetermined time, not only it is determined that the ports are physically connected and this is displayed on the display in the maintainer interface 4, but also that the information stored in the database (DB) and the connection between the ports are checked and the result is shown on the display in the maintainer interface 4, in step S46.

Accordingly, in step S47, the maintainer 7 can check whether the connection between the port #3 of the card #1 of the network element 12 (NE#A) and the port#4 of the card #3 of the network element 13 (NE#B) is identical to the connection information stored in the database in the display showing the indication. Consequently, a comparison between the set information and the actual operation and a misconnection, an incomplete construction and transmission interruption can be preliminary surveyed.

### EMBODIMENT 3

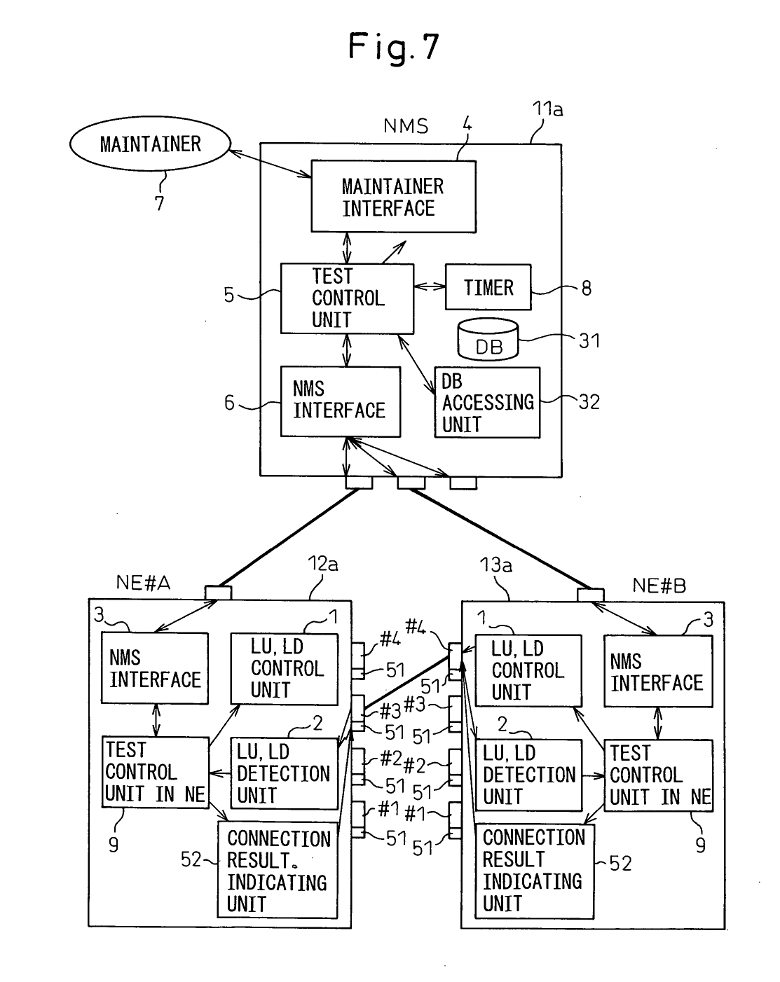

FIG. 7 is a block diagram showing a large scale network structure according to embodiments subsequent to a third embodiment of the present invention. In the drawing, it is different from FIG. 4 that each of the network elements 12a (NE#A) and 13b (NE#B) is further comprised of indication lamps 51 such as LEDs near the ports #1 to #4, respectively, and a physical link connection result indication unit 52. The remaining structure is identical to that shown in FIG. 4, and no duplicate explanation will be given.

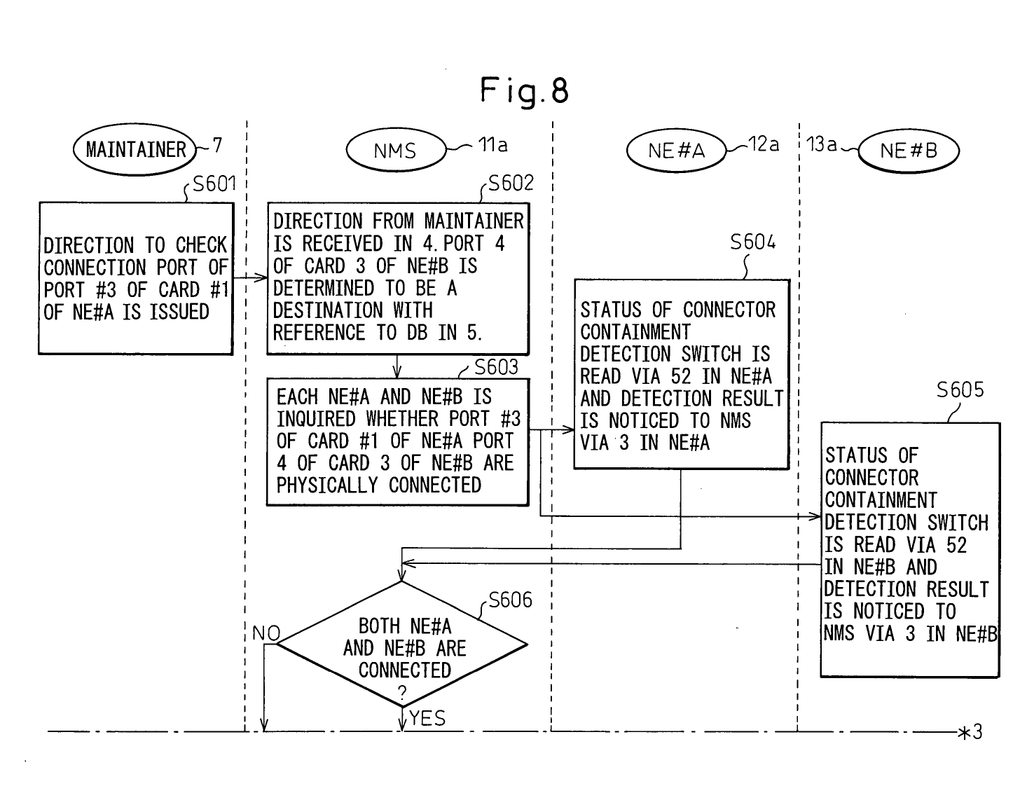

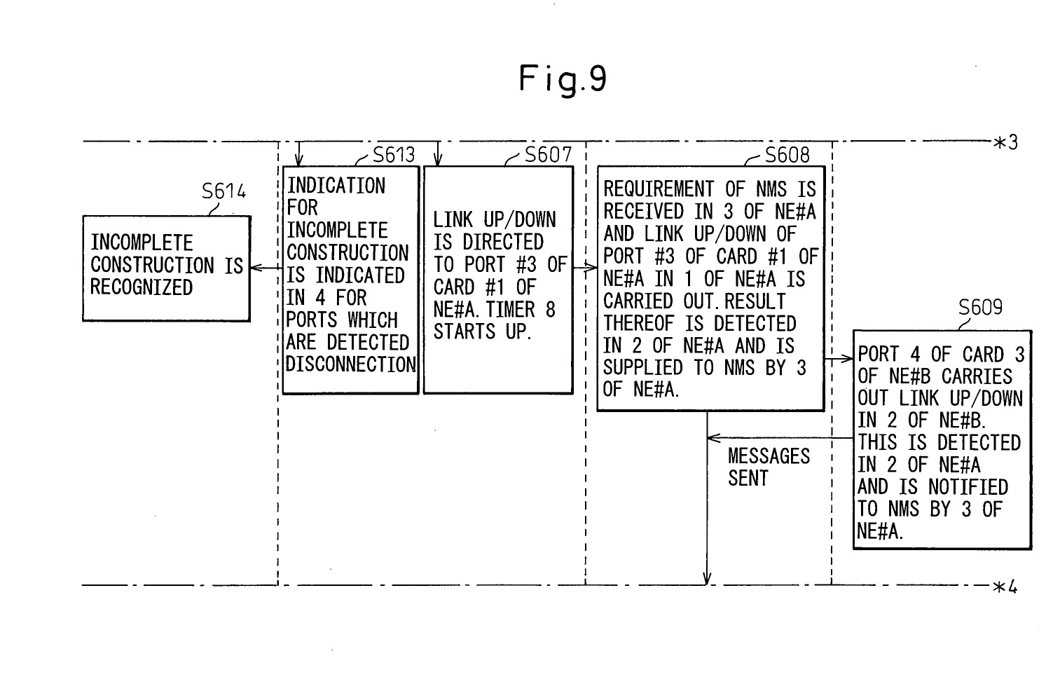

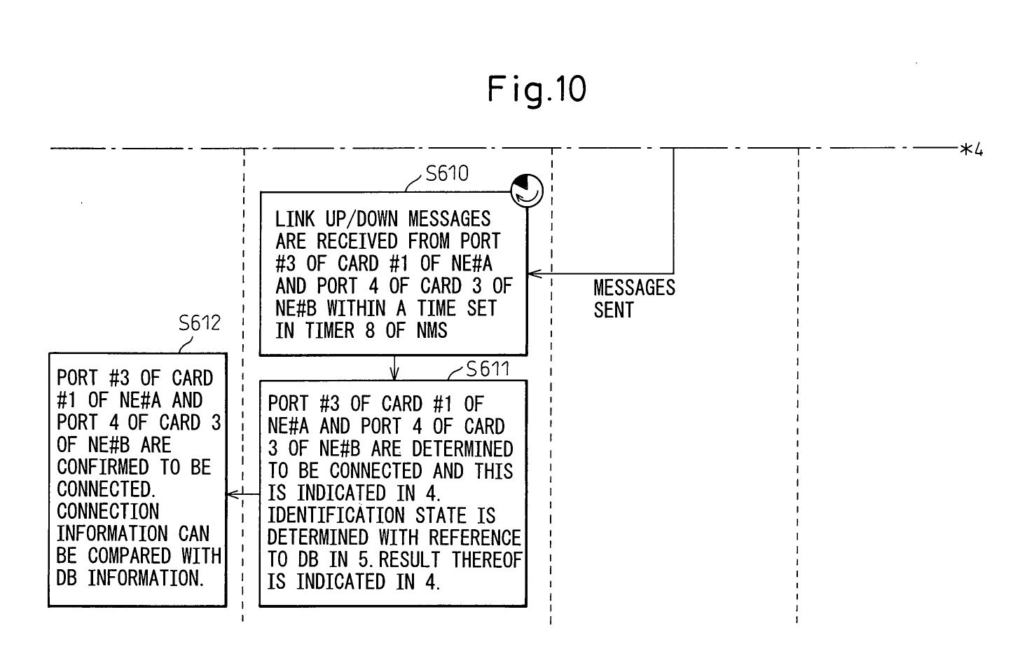

FIGS. 8, 9 and 10 show sequence diagrams illustrating the physical connection detecting operation of the transmission link in the large scale network shown in FIG. 7. The physical connection detecting operation of the transmission link with reference to FIGS. 8-10.

In the third embodiment, confirmation of the misconnection or the incomplete construction in the second embodiment is carried out. Step S601 is identical to the step S41 in FIG. 5.

In the step S602, the instruction from the maintainer is received in the maintainer interface 4 in the network management system (NMS) 11a and is checked against the contents of the database (DB) 31 in the test control unit 5 to thereby determine that, for example, the port #4 of the card #3 of the network element 13b (NE#B) is the port to connect.

In step S603, it is inquired to each network elements 13a (NE#A) and 13b (NE#B) if the port #3 of the card #1 of the network element 13a (NE#A) is physically connected to the port#4 of the card #3 of the network element 13b (NE#B).

In response to the inquiry, in the network management system 13a (NE#A), the status of a connector containment detection switch is read via the physical link connection result indication unit 52, and the result is noticed to the network management system (NMS) 11a via the NMS interface 3, in step S604.

Likewise in the network management system 13b (NE#B), in response to the inquiry, the status of the connector containment detection switch is read via the physical link connection result indication unit 52, and the result is noticed to the network management system (NMS) 11a via the NMS interface 3, in step S605.

In step S606 it is determined whether connectors are connected in both the network management system 13a (NE#A) and the network management system 13b (NE#B).

If the determination is yes in the step S606, the same operations as that of steps S42 to S47 in FIG. 5 and FIG. 6 are performed in steps S607 to 612.

If the determination is no in step S606, the process goes to step S613 and an indication of construction incomplete is shown regarding the port which has been reported to be disconnected, in the maintainer interface 4 of the network management system (NMS) 11a. Consequently, the maintainer 7 can recognize that the construction is incomplete in step S614.

As discussed above, according to the third embodiment, after the connection status of the connectors are checked, if the connector is connected, then it is determined that construction is complete, the link up/down is carried out of the port by the same operation as that of the second embodiment, the connection to the opposed port is confirmed, the confirmation result is compared with the database contained in the network management system, and the result is displayed. If the connector is not connected, the fact that the construction is incomplete can be noted.

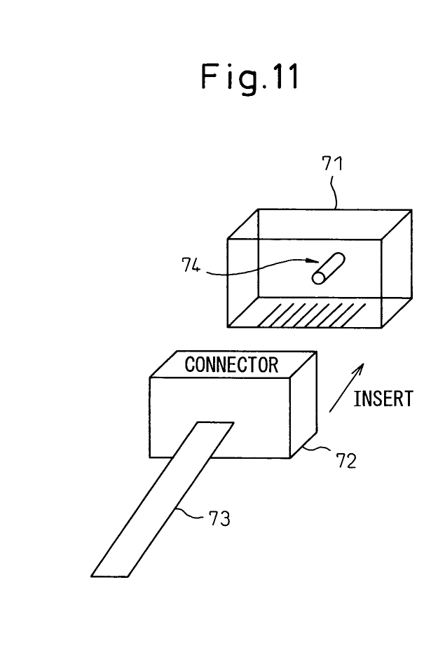

FIG. 11 is a schematic view of the connector containment detection switch. RJ45 is used here as an example, and a similar switch is provided at the connecting portion of an optical fiber in case of GbE. In the drawing, numeral 71 represents a switch side, numeral 72 represents a connector, numeral 73 represents a cable, and a numeral 74 represents a connector containment detection switch. If the connector 72 is inserted in the switch side 71, the connector containment detection switch 73 is pushed and thereby the switch turns ON. If the connector 71 is released from the switch side 71, the pushed down connector containment detection switch 73 is released and the switch turns OFF. This ON/OFF of the switch is detected by the physical link connection result indication unit 52.

### EMBODIMENT 4

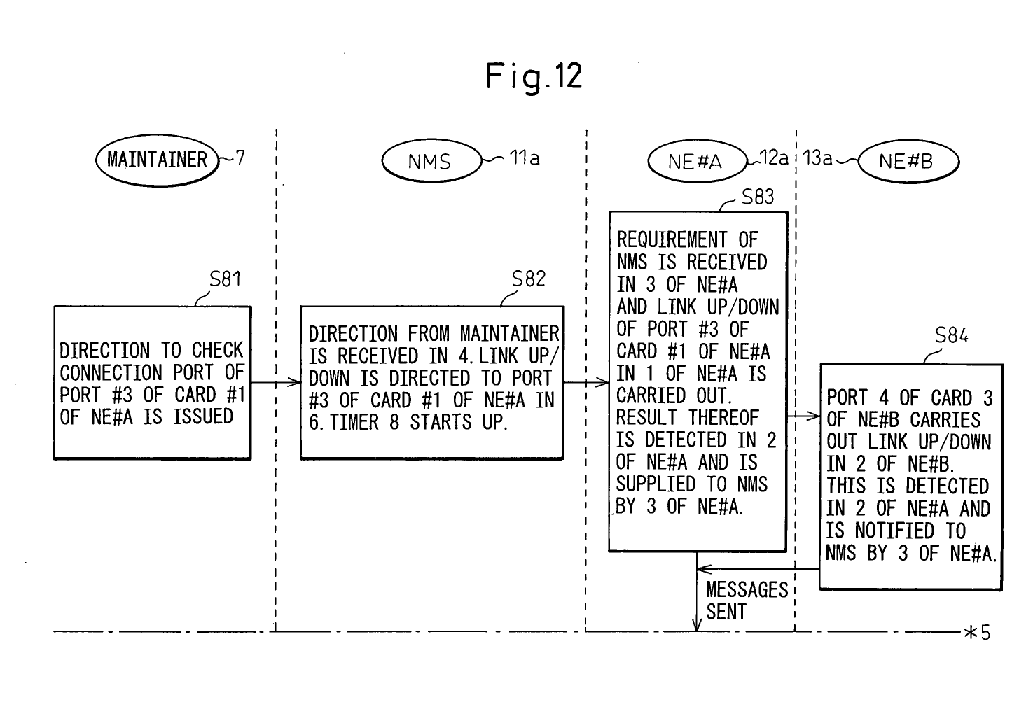

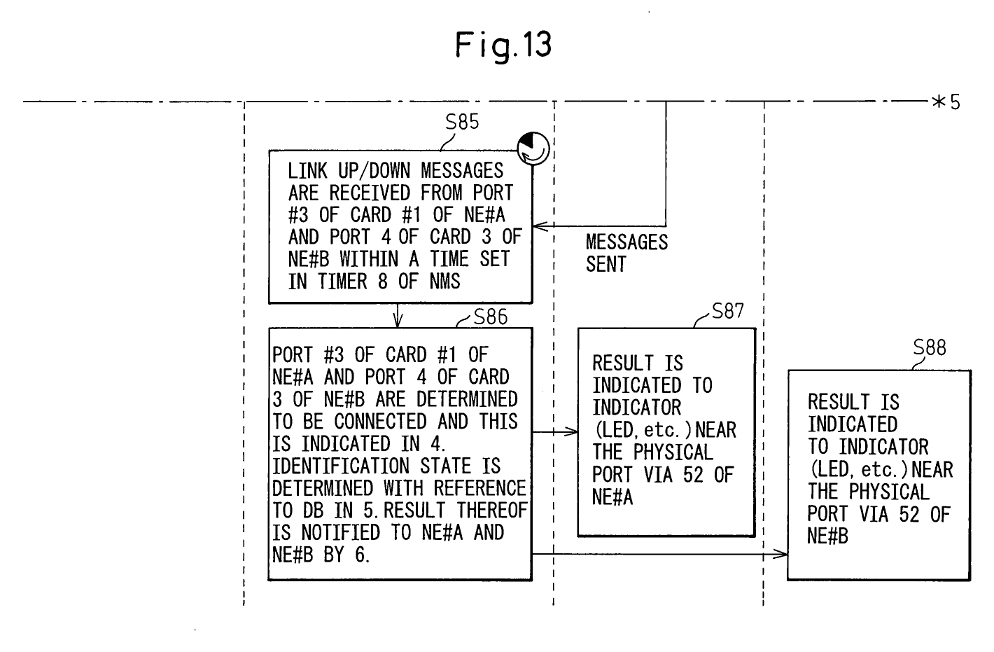

FIG. 12 and FIG. 13 show sequence diagrams illustrating the physical connection detecting operation of the transmission link in the large scale network shown in FIG. 7.

Steps S81 to S85 in FIG. 12 and FIG. 13 are identical to steps S41 to S45 in FIG. 5 and FIG. 6, and therefore, no duplicate explanation will be given. In step S86, the result of comparison with the data in the database (DB) 31 is supplied to the network element 13a (NE#A) and the network element 13b (NE#B) from the NE interface 6, in this embodiment.

In step S87, the comparison result is indicated in the indicator (LED) 51 near the physical port of the network element 13a (NE#A) via the physical link connection result indication unit 52 in the network element 13a (NE#A).

In step S88, the comparison result is indicated in the indicator (LED) 51 located near to the physical port of the network element 13b (NE#B) via the physical link connection result indication unit 52 in the network element 13b (NE#B).

As described above, according to the fourth embodiment, the comparison result of the data in the database and the connected link can be indicated in the indication unit of the network element, and thus, the connecting operator on the network element side can confirm whether the connection port is correct. Moreover, in case of misconnection, the connection operator of the network element can be informed of the misconnection and the correct connection port.

### EMBODIMENT 5

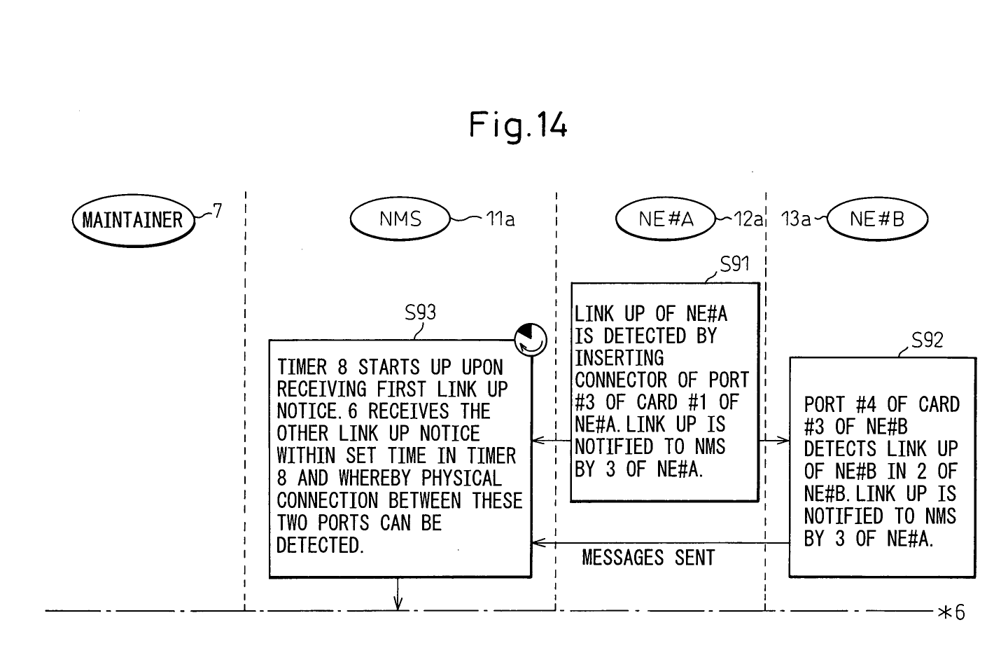

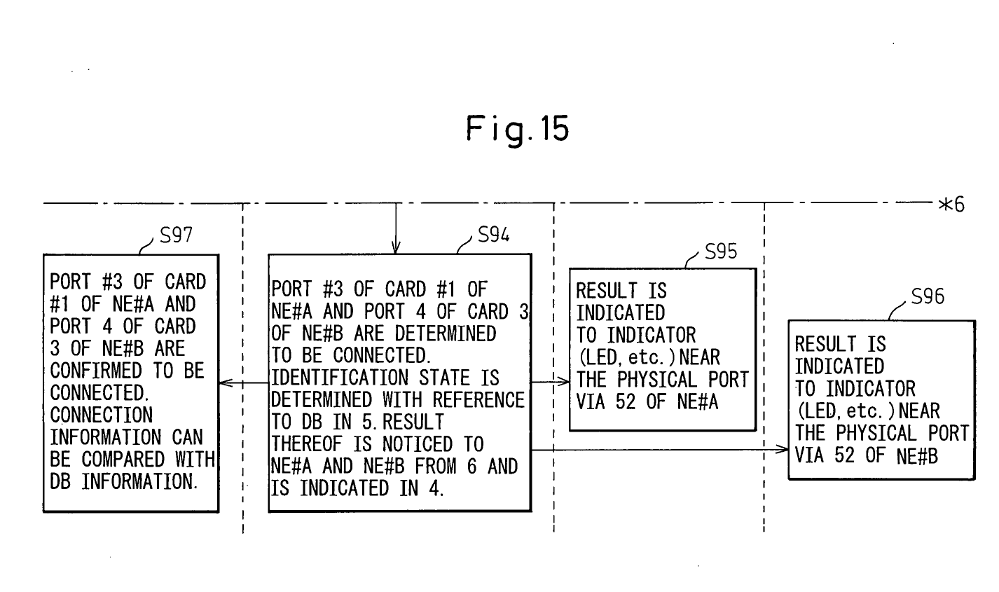

FIG. 14 and FIG. 15 show sequence diagrams illustrating the physical connection detecting operation of the transmission link in the large scale network shown in FIG. 7.

In this embodiment, the connecting operator of the network element 12 (NE#A) inserts the connector, when connecting, in, for example, the port #3 of the card #1 of the network element 12 (NE#A) to link up, and thereby notify the network management system (NMS) 11.

Furthermore, if the connector is inserted in the port of the network element 12 (NE#A), a direction to link up is automatically issued from the network element 12 (NE#A) to the network element 13 (NE#B). In step S92, the connecting operator of the network element 13 (NE#B) detects the link up of, for example, the port #4 of the card #3, of the network element 13 (NE#B), and notifies the link up to the network management system (NMS) 11 via the NMS interface 3 in the network element 13 (NE#B).

In the network management system 11, in step S93, if a first notification of the link up is received, the timer 8 starts up. The NE interface 6 receives the other notification of link up within the set time of the timer 8, whereby the physical connection between the two ports can be detected.

In the following steps S94 to S96, the same operations as the steps S86 to S88 in FIG. 13 are carried out, and the comparison result of the data in the database and the connected link is shown in the indication unit of the network element. Consequently, the connecting operator in the network element side can confirm whether the connection port is correct or the connection has failed. In case of the misconnection, this is notified to inform the connecting operator of the network element the correct connection port.

In the network management system (NMS) 11, the maintainer 7 sees the indication on the display and can identify the connection between the port #3 of the card #1 of the network element 12 (NE#A) and the port #4 of the card #3 of the network element 13 (NE#B) and the connection stored in the database on the display. Accordingly, the set information and the actual work can be compared and thus a misconnection, an incomplete construction or a transmission interruption can be preliminarily predicted.

### EMBODIMENT 6

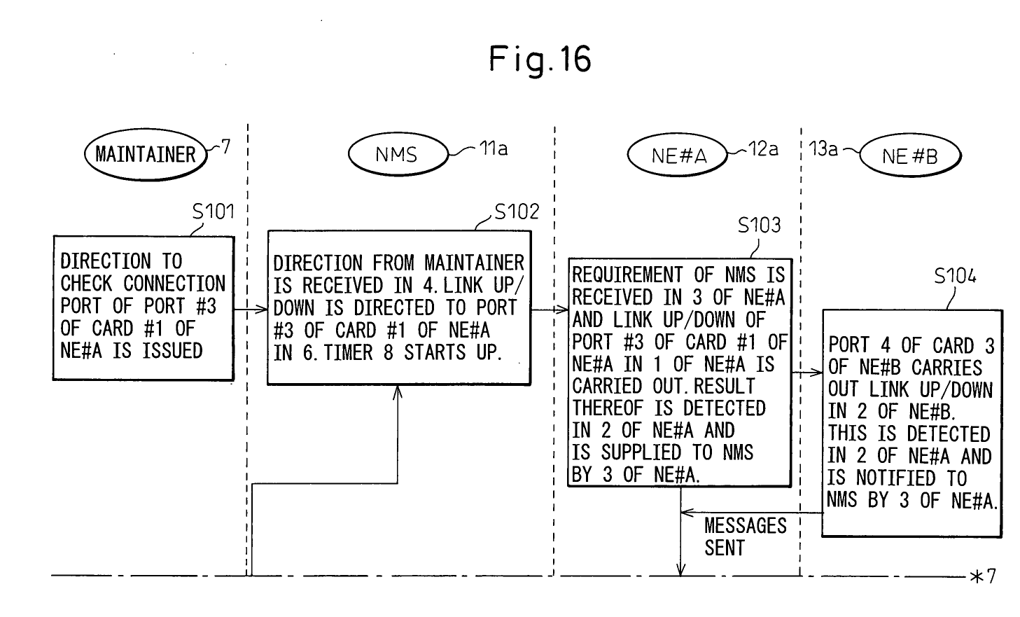

FIGS. 16-18 show sequence diagrams illustrating the physical connection detecting operation of the transmission link in the large scale network shown in FIG. 7 according to the sixth embodiment of the present invention. In the drawings, steps S101 to S104 are identical to the steps S81 to S84 in FIG. 12 and no duplicate explanation will be given.

In the present embodiment, it is determined whether or not three or more messages are received within the set time of the timer 8 in step S105. When three or more messages are received, for example, a link up/down direction for the port #4 of the card #1 of the network element 12 (NE#A) can be incidentally generated for some reason, as shown in step S106. If the three or more messages are received within the set time, steps S102 to S104 are repeated until the number of the messages received in the set time is two or less.

If the determination is NO in the step S105, steps S106 to S109, which are identical to steps S94 to S97 in FIG. 15, are performed.

As described above, in the present embodiment, when the network management system (NMS) 11 performs link up/down to the relevant port, if the same message is received from the other port than the relevant opposite port for some reason, the link up/down direction is issued again to thereby confirm the correct port.

### EMBODIMENT 7

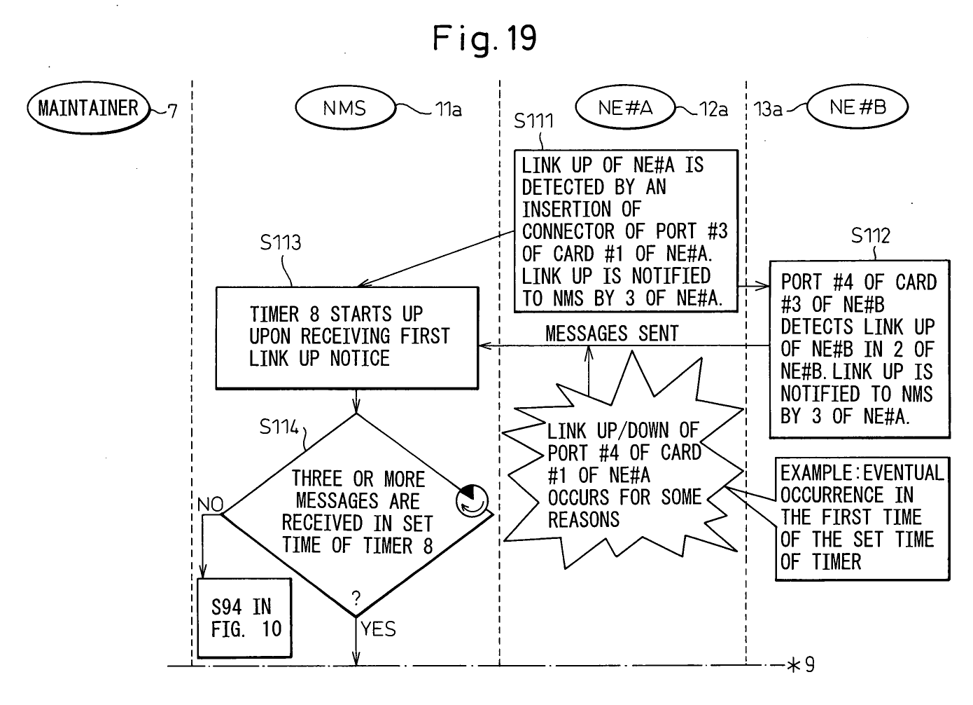

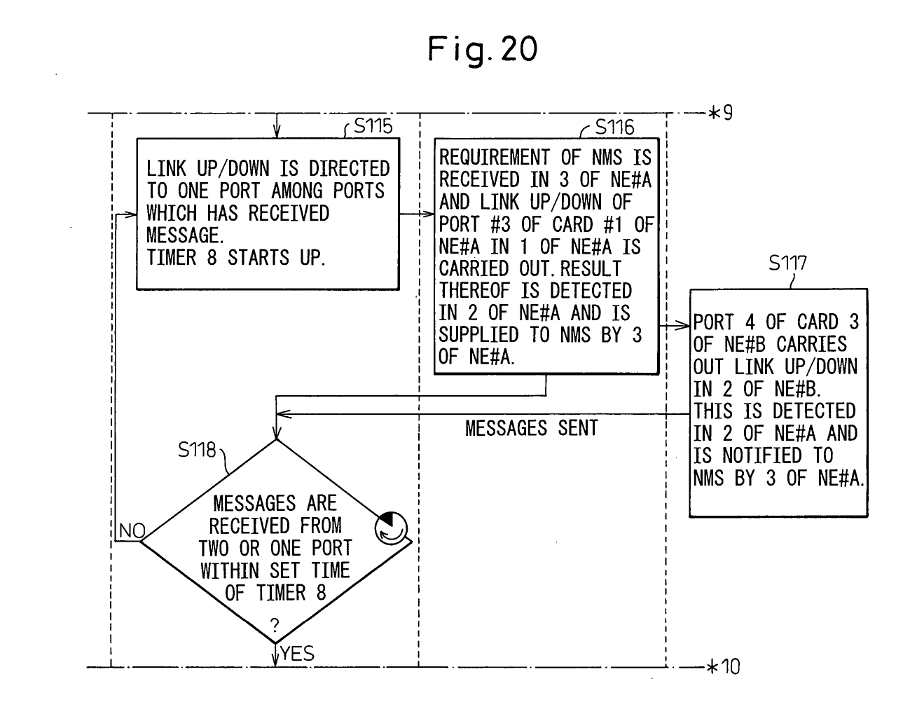

FIGS. 19-21 are sequence diagrams illustrating the physical connection detecting operation of the transmission link in the large scale network shown in FIG. 7 according to the seventh embodiment of the present invention. In the drawings, steps S111 and S112 are identical to the steps S91 and S92 in FIG. 14, and no duplicate explanation will be given.

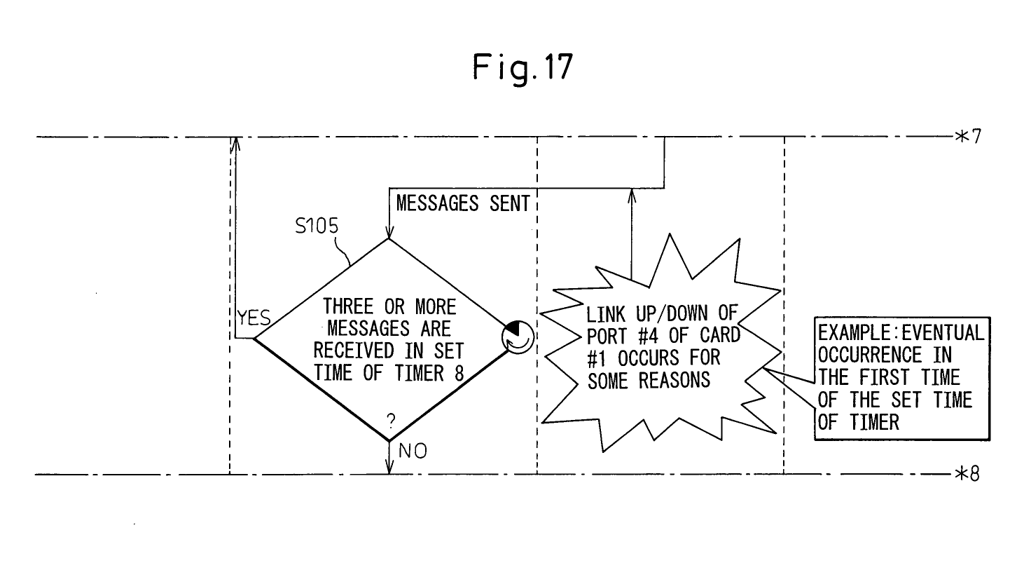

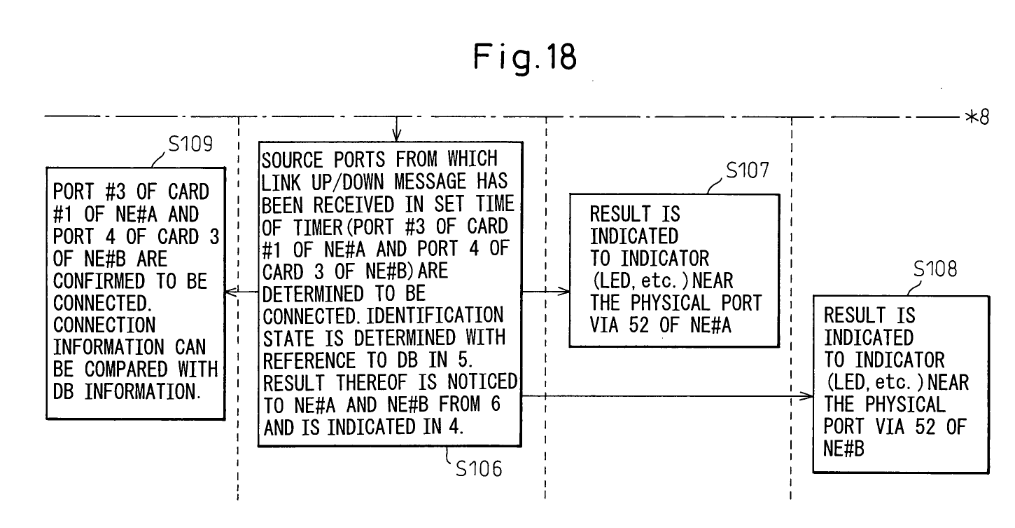

In the present embodiment, as in the step S105 in FIG. 17, if the network management system (NMS) 11a receives a message of link up/down, the timer 8 starts up. However, as in the step S106 in FIG. 18, if a link up/down direction for the port #4 of the card #1 of the network element 12 (NE#A) is generated for some reason, three or more messages can be received within the set time of the timer 8. Consequently, in step S114, it is determined whether or not three or more messages are received within the set time of the timer 8. If the result of the determination is NO, the same performance as steps after step S94 in FIG. 15 is carried out. If the result of the determination is YES, the flow goes to step S115, and a link up/down direction is issued to one of the ports that have received the message and the timer 8 in the network management system (NMS) 11a starts up again.

After that, the same operation as in steps S103 to S105 in FIG. 16 and FIG. 17 is repeated in steps S116 to S118. Namely, the steps S115 to S118 are repeated until it is determined that the message is received from two or one port within the set time of the timer 8, and when the determination is YES, the flow goes to step S119 in which the network management system (NMS) 11a determines to have received a link up/down message of the port #3 of the card #1 of the network element 12 (NE#A) and the port #4 of the card #3 of the network element 13 (NE#B), and after that, an operation, which is the same as that in steps S106 to S109, is carried out in steps S120 to S123.

If the network management system receives three or more messages of link up/down, the network management system cannot determine the correct connection port, however, according to the present embodiment, the correct connection port can be confirmed by the link up/down to one port among the ports from which the messages are received.

### EMBODIMENT 8

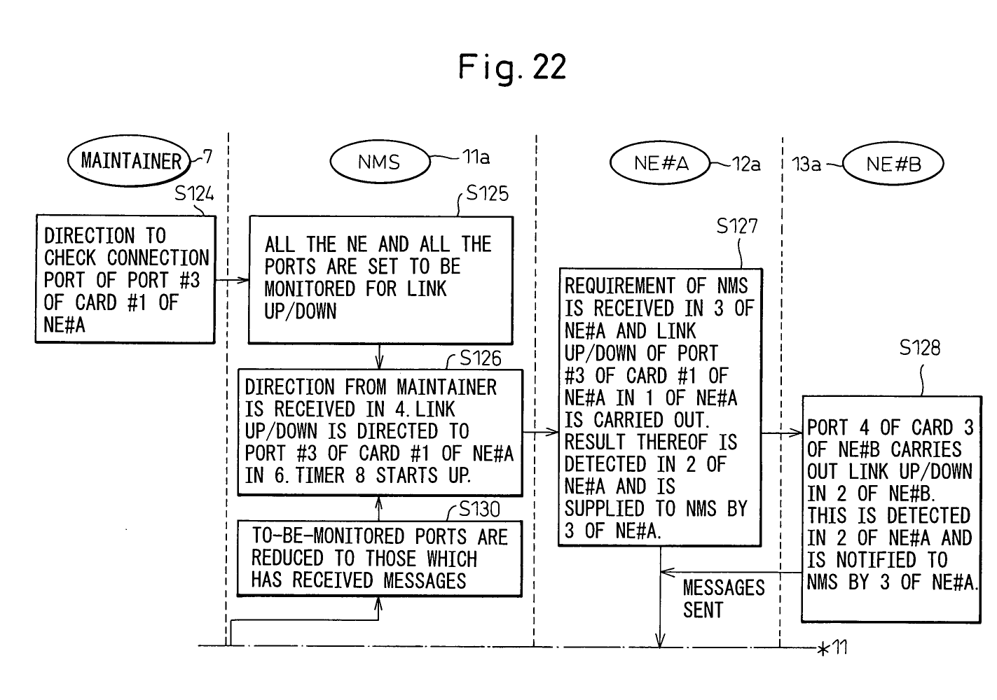

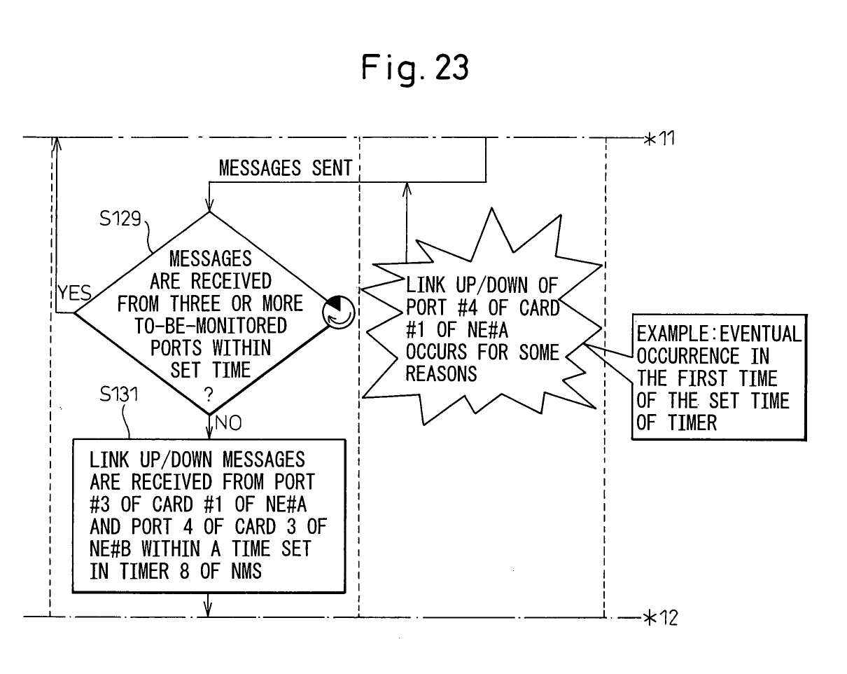

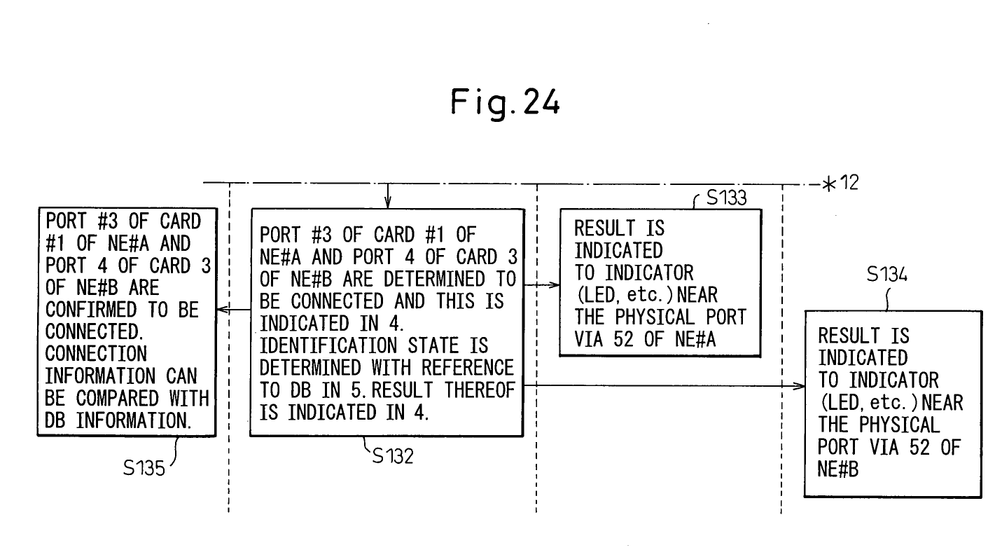

FIGS. 22-24 show sequence diagrams illustrating the physical connection detecting operation of the transmission link in the large scale network shown in FIG. 7 according to the eighth embodiment of the present invention. In the drawings, step S124 is identical to step S101 in FIG. 16 and steps S127 to S129 are identical to the steps S102 to S105 in FIG. 16 and FIG. 17, therefore, a duplicate explanation will not be given.

In the present embodiment, after step S124, all the network elements and all the ports subordinated to the network management system (NMS) 11a are set as objects to be monitored regarding the link up/down.

In step S129, if a message is received from three or more ports which are monitored within the set time, the flow goes to S130 and a port that have preciously received the message is limited to be targeted as the monitoring object. After that, the steps S126 to S129 are repeated.

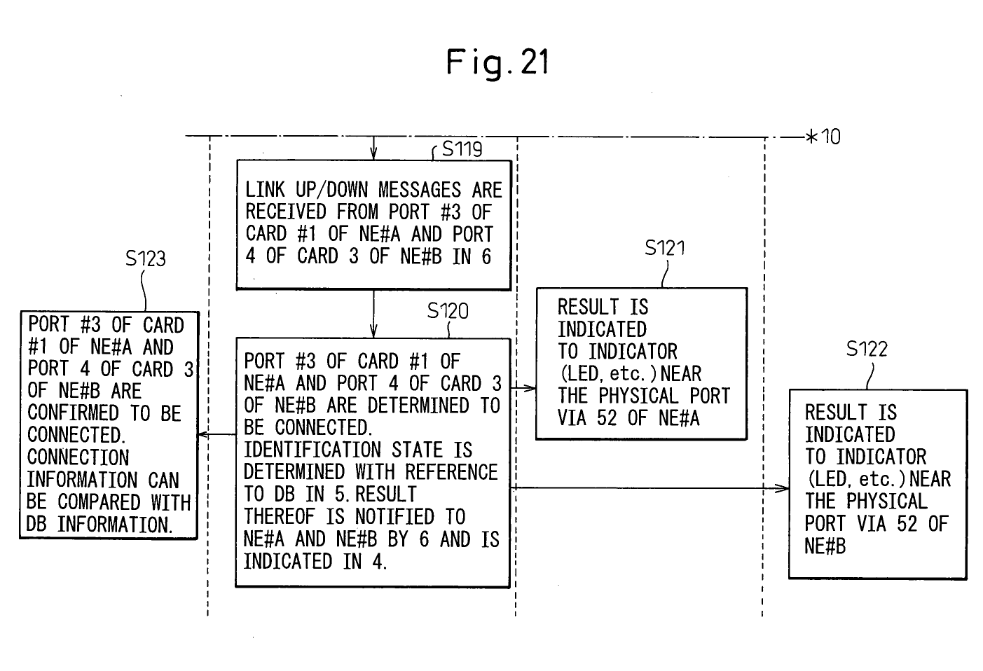

If the number of the message received in the monitored ports is reduced to two or less in the determination of the step S129, the flow goes to step S131 in which it is determined that, for example, the port #3 of the card #1 and the port #4 of the card #3 of the network element 13 (NE#B) receive the link up/down message in the NE interface 6 within the set time of the timer 8. After that, operations identical to that of steps S120 to S123 in FIG. 21 are carried out in steps S132 to S135.

As described above, in the eighth embodiment, when the link up/down message is received from three or more ports which are monitored by the network management system, the port to be monitored is limited until the number of received messages within the set time is decreased to two or less by limiting the monitored port to a port which have previously received the link up/down message, and therefore, the time to detect the to-be-connected port can be reduced.

### INDUSTRIAL APPLICABILITY

According to the present invention, a physical connection between network elements in a large scale network can be confirmed easily and quickly.

In the present invention, a link connection procedure for a general Ethernet (registered trademark) link, as defined by the IEEE, is carried out for network elements at both ends of a test link, and the result thereof is monitored and determined in a network management system to thereby confirm the link connection.

The link connection procedure by IEEE can be used in a general device and, hence, the present invention can be applied to general devices and a network management system to manage the devices, which is a general network structure.

1. A network comprised of plural network elements and a network management system to manage the plural network elements, wherein
said network elements performs a link up to change the status of one port among the plural ports from an unusable state to a usable state or a link down to change the status of one port among the plural ports from a usable state to an unusable state according to a direction from the network management system,
after the direction of the link up or link down is supplied to the network element, said network management system monitors messages of a responding link up or a responding link down from the plural network elements to be monitored, and when the responding link up or responding link down is received from a port which is different from a port from which the link up or link down has been directed within a predetermined time before or after an issuance of the link up or link down direction, a physical connection status between the port from which the link up or link down has been directed and a port from which the responding link up or responding link down has been sent to the network management system is recognized.

2. A network according to the claim 1 in which the network management system has a database storing a network structure regarding a physical connection between the network elements, an identification means to identify a physical connection status between a ports recognized by the responding link up or link down and information set in the database, and an indication means to indicate the identification result on the network management system.

3. A network according to claim 2 in which
each of the network elements is provided with an interface port between the opposed network element, a connector containment detection switch to detect containment of a connector provided on the interface port, and a means for switching an output notice to notify an output of the connector containment detection switch to the network management system and, when a link up or link down direction is issued to one port of a physical link registered in the network structuring information stored in the network management system, if the responding link up or link down message is not received from a port different from a port to which the link up or link down is directed within the predetermined time, a reason of not receiving the responding link up or link down can be recognized according to a content of the notice by the means for switch output notice.

4. A network according to claim 2, wherein
the result of the comparison detected in the network management system is notified to the network element and is indicated on the network element.

5. A network according to claim 1, wherein
a function to monitor that a link up message is autonomously generated by chance of connecting a cable to a port of the network element when a cable connection for a physical link between the network element in the network management system is provided and when the network management system receives the link up message, if another link up message is received from different port among the to-be-monitored network element group within a predetermined time before or after the receipt of the message, the network management system determines that the two ports are physically connected

6. A network according to claim 5 wherein,
if a network structure regarding the physical connection between the network elements is previously held in the network management system, the physical connection detected in the network management system is compared with the stored set information, and the comparison result is indicated on the network system.

7. A network according to claim 5, wherein
the comparison result detected in the network management system is notified to the network element, and is indicated on the network element.

8. A network according to claim 1 wherein,
if the network management system receives a response linkup/down messages from two or more ports except for a port which has directed the link up or link down within a predetermined time, the direction of the link up or link down is repeated until the number of the message of the response link up or link down decreases to one within a predetermined time before or after the receipt of the direction of the link up or link down from the network management system so as to confirm a link connection between the network element.

9. A network according to claim 1 wherein, if the network management system receives response linkup/down messages from three or more ports within a predetermined time, one port is selected from among ports which has sent the messages of the link up or link down, and a link up or link down direction to the selected port is repeated from the network management system until the number of the link up/down messages received within a predetermined time decreases to one to confirm a link connection between the network elements.

10. A network according to claim 5 wherein
to-be-monitored ports for the link up or link down messages from the network elements are limited to a port group which has received the messages within the previous monitoring period to thereby reduce the number of the to-be-monitored objects, whereby the number of the repeated link up or link down directions can be reduced.
